(19) United States
(12) Patent Application Publication
(10) Pub. No.: US 2016/0227609 A1
(43) Pub. Date: Aug. 4, 2016

(54) MULTI FUNCTION GLASS OR GLASS-CERAMIC COOKTOP SYSTEM AND METHOD OF COOKING THEREON

(71) Applicant: SCHOTT Corporation, Elmsford, NY (US)

(72) Inventors: Martin Taplan, Mombach (DE); Sascha Backes, Ruedesheim (DE); Silke Heinrich, Wiesbaden (DE); Karen J. Wegert, Louisville, KY (US); Theodore A. Wegert, Louisville, KY (US)

(21) Appl. No.: 14/609,467

(22) Filed: Jan. 30, 2015

(51) Int. Cl. H05B 3/74

(52) U.S. Cl. CPC H05B 3/74; H05B 2213/05

(57) ABSTRACT

A cooktop system with a glass or glass-ceramic cooktop system is provided. The cooktop system has a heating area that has a heating element thermally connected thereto and a limiter system so that the cooktop is suitable for a standard cooking operation at a first limit and suitable for a non-standard cooking operation at a second limit different from the first limit.

### BACKGROUND OF THE DISCLOSURE

1. Field of the Disclosure

The present disclosure is related to a glass or glass-ceramic cooktop system and a use thereof in methods for performing multiple food cooking operations. More particularly, the present disclosure is related to a glass or glass-ceramic cooktop system having a glass or glass-ceramic cooktop with one or more cooking zones and two or more limiters or limiter settings for adapting to varying time-temperature load requirements between a standard cooking operation and a non-standard cooking operation.

2. Description of Related Art

Cooktops in residential settings are generally used for standard cooking operations. As used herein, a “standard cooking operation” refers to the use of a cooktop for cooking in pot sizes that are typically found in residential kitchens, cooking food volumes that are typically prepared in residential kitchens, and cooking at parameters (e.g., temperature, time) that are typically used in residential kitchens.

However, many cooktops are also used for a non-standard cooking operation. As used herein, a “non-standard cooking operation” refers to the use of a cooktop for cooking in larger pot sizes, larger food volumes, and higher cooking parameters than are typically used in residential kitchens. One such “non-standard cooking operation” is canning. Canning has larger requirements, especially with respect to time and temperature load requirements, than standard cooking operations.

More specifically, canning is a process used to preserve food in a sealed and airtight container. Canning increases shelf life and prevents food from spoiling. During a canning operation, food is preserved by first heating the food, and then by excluding air. Foods that are being canned are typically placed in canning jars and sealed with a lid that includes a rubber gasket or an o-ring. For canning operations, canning jars are usually heated in a water bath or in a sealed pressure canning pot to a canning temperature that is specific to the type of food being canned and are then maintained at the canning temperature for a certain period of time for sterilization.

Canning operations can take a very long time compared to standard cooking operations. One reason for this is that large diameter and tall pots must be used to accommodate the large amounts of cooked material, including the pot, water, jars, and food. Unfortunately, many commercially available cooktops are not suitable for use with non-standard cooking operations such as those present in canning.

Accordingly, it has been determined by the present disclosure that there is a need for cooktops that can effectively handle both standard and non-standard cooking operations.

### BRIEF SUMMARY OF THE DISCLOSURE

The present disclosure provides a glass or glass-ceramic cooktop system having a glass or glass-ceramic cooktop with a cooking zone and a cooking-zone regulator so that both non-standard cooking operations and standard cooking operations can interchangeably occur.

The present disclosure provides such a glass or glass-ceramic cooktop having one or more adapted cooking zones in which both non-standard and standard cooking operations can interchangeably occur without limiting the cooking time for the standard cooking operation.

The present disclosure also provides such a glass or glass-ceramic cooktop system that provides protection against overheating for both the non-standard and standard cooking operations.

The present disclosure further provides such a glass or glass-ceramic cooktop system in which the glass or glass-ceramic cooktop has an adapted heating area, and the system has a heating element that is thermally connected to the heating area, with the heating element also having a limiter system that adjusts for or implements a standard cooking operation and a non-standard cooking operation.

The present disclosure still further provides that the limiter system has a first limit suitable for a standard cooking operation and a second limit, different from the first limit, suitable for a non-standard cooking operation.

The present disclosure still further provides that the limiter system is a two-step limiter with a first step suitable for a standard cooking operation and a second step, different from the first step, suitable for a non-standard cooking operation.

The present disclosure yet further provides such a glass or glass-ceramic cooktop system that has a selector switch, which enable the user to select the desired cooking operation, or that has a sensor which automatically selects the needed operation by detecting the pot diameter.

A cooktop system has a glass or glass-ceramic cooktop, a control panel, a control system, and at least one heating zone. The control system, the control panel, and the at least one heating zone are operatively connected. Further, the control system has a first temperature limiter setting that is suitable for a standard cooking operation and a second temperature limiter setting that is suitable for a non-standard cooking operation. The second temperature limiter setting is different from the first temperature limiter setting.

The above-described and other features and advantages of the present disclosure will be appreciated and understood by those skilled in the art from the following detailed description, drawings, and appended claims.

### BRIEF DESCRIPTION OF THE SEVERAL VIEWS OF THE DRAWINGS

FIG. 1 shows a glass or glass-ceramic cooktop of the cooktop system of the present disclosure with a touch sensor control panel according to an embodiment of the present disclosure.

FIG. 2 is a schematic of a control panel circuit for the glass or glass-ceramic cooktop of FIG. 1.

FIG. 3 is a top view of a dual ribbon heater with a two temperature limiter for the glass or glass-ceramic cooktop of FIG. 1.

FIG. 4 is a cross sectional view taken along lines 4-4 of the dual ribbon heater of FIG. 1.

FIG. 5 is a flow diagram of a cooking operation performed on the glass or glass-ceramic cooktop of FIG. 1.

FIG. 6 is a schematic of a second control circuit for the glass or glass-ceramic cooktop system of the present disclosure.

FIG. 7 shows a glass or glass-ceramic cooktop with selector elements according to a second cooktop embodiment of the present disclosure.

FIG. 8 shows a glass or glass-ceramic cooktop with touch sensors according to a third cooktop embodiment of the present disclosure.

FIG. 9 shows a glass or glass-ceramic cooktop having cooking zones or cooking areas according to a fourth cooktop embodiment of the present disclosure.

FIG. 10 shows the glass or glass-ceramic cooktop and control panel according to the present disclosure incorporated into a stove or oven with the control unit in the front.

FIG. 11 shows the glass or glass-ceramic cooktop and control panel according to the present disclosure incorporated into a stove or oven with the control unit in the back.

### DETAILED DESCRIPTION OF THE DISCLOSURE

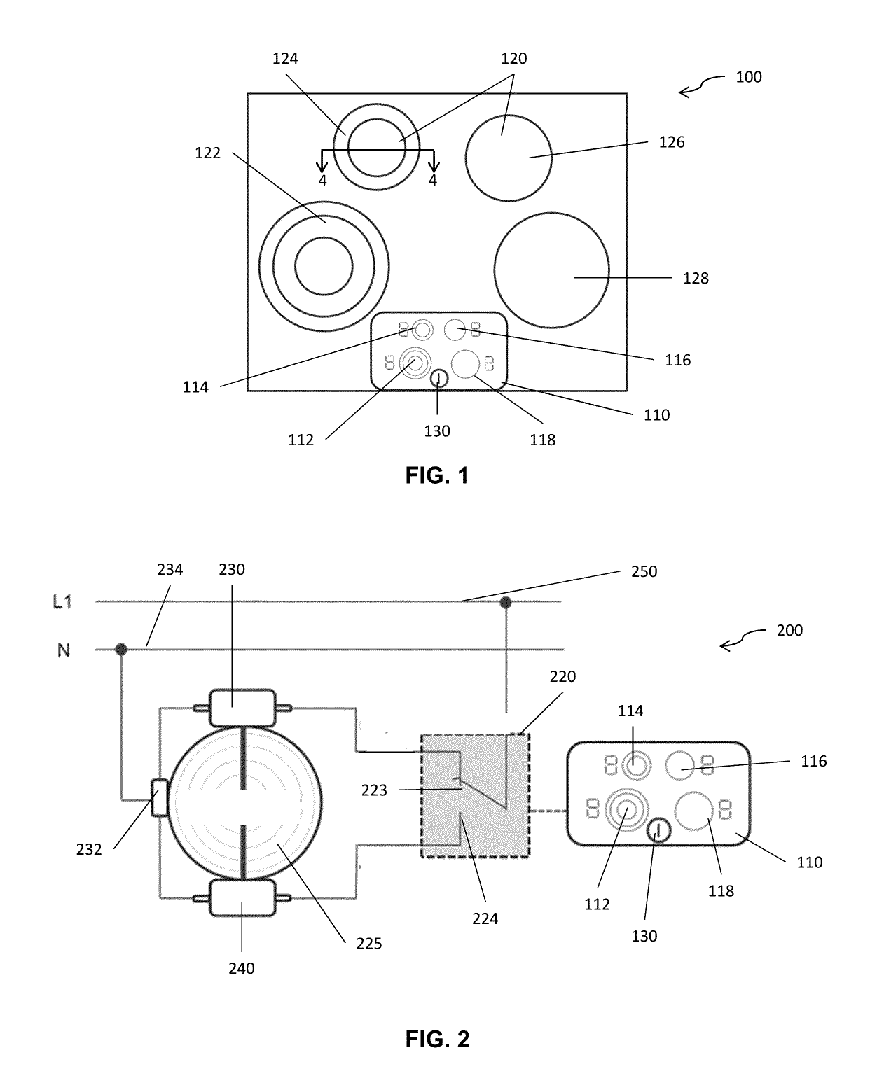

Referring to the drawings and in particular to FIG. 1, there is shown a glass or glass-ceramic cooktop system having a glass or glass-ceramic cooktop according to the present disclosure generally referenced by numeral 100. Cooktop 100 has a control panel 110, multiple cooking zones 120 and selector switch 130. In the embodiment shown in FIG. 1, cooking zones 120 are four discrete cooking zones, namely zone 122, zone 124, zone 126, and zone 128. As shown in the embodiment of FIG. 1, each cooking zone of cooktop 100 is a different size. Size, as used in the present disclosure, means the area receiving heat from a heating element and within which heat is transferred to any article placed thereon. In other embodiments of the present disclosure, cooking zones 120 can be the same size, or combinations of the same and different sizes. Although illustrated as four zones, there can be any number of zones including just one zone 120 and, if more than one zone, any combination of sizes feasible in the surface area of the cooktop 100. Also, cooking zones 120 on a cooktop 100 can have different configurations, although the same configuration, such as circular, is preferred.

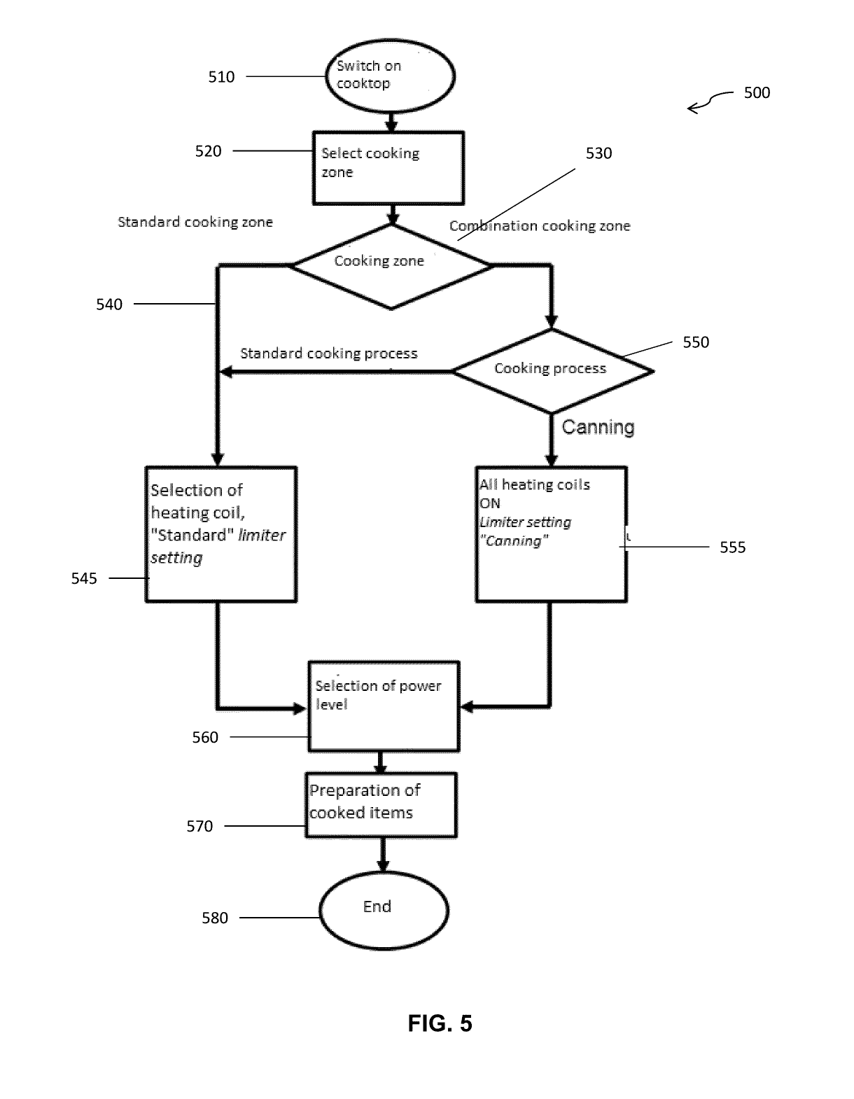

In an exemplary embodiment, at least one cooking zone, such as, for example, cooking zone 122 can be a combination cooking zone in which a standard cooking operation or a non-standard cooking operation, such as canning, can be carried out. For such a cooking zone 122, the user will need to specify which of the two operations is to be used prior to commencement of the cooking process. This selection will be discussed in detail with respect to FIG. 5.

Each cooking zone 120 is heated by a radiant heating element 225 shown in FIG. 2. The radiant heating element(s) 225 are situated beneath cooktop 100. Preferably, one heating element 225 is located under each cooking zone 122, 124, 126, and 128, and all heating elements 225 are thermally connected to cooktop 120.

Control panel 110 is, in the embodiment of FIG. 1, a touch sensor control panel. Control panel 110 has controls 112, 114, 116 and 118 for energizing and de-energizing, i.e., turning on and off, and for selecting the power level of the selected cooking zones and corresponding radiant heating elements. As shown in FIG. 1, cooking zones 122, 124, 126 and 128 are energized or deenergized by power controls 112, 1114, 116 and 118, respectively. As an example, the control for the power level for cooking zone 128 can be on a scale of 1 to 10, low to medium to high, or some other power differentiating scale setting, by actuating power control 118. Control panel 110 has an on/off or power switch 130 for turning on and off cooktop 100. Controls 112, 114, 116, and 118 can be used for selecting which type of cooking operation is to be undertaken, such as a standard operation or a non-standard cooking operation. Alternatively, it is envisioned that an additional switch or series of switches in control panel 110 can be used for selecting which type of cooking operation is to be undertaken. The non-standard cooking operation is, for example, a canning operation that normally has the time and temperature concerns noted above. Selector switch 112 is operatively connected to the radiant heating elements via relay switch 220, and can vary the time-temperature load requirements for different cooking operations.

Cooktop 100 is operated, as shown in FIG. 2, by a control circuit 200 of heating element 225 of the present disclosure. To facilitate the explanation of the cooktop system, control panel 110 is reproduced in FIG. 2 along with control circuit 200 of heating element 225. Control circuit 200 includes a relay switch 220 connected to control panel 110, and a limiter system. As shown in FIG. 2, the limiter system has a first limiter 230 connected to one pole or contact setting 223 of relay switch 220 and a second limiter 240 connected to a second pole or contact setting 224 of relay switch 220. However, the present disclosure provides, in another embodiment, that the limiter system can be a two-step limiter. Selector switch 112 of control panel 110 is used by the user to select the cooking operations. Relay switch 220 controls which of contact setting 223 and contact setting 224 is engaged. First limiter 230 and second limiter 240 are each selectable for limiting a temperature and power load of heating element 225. Further, first limiter 230 and second limiter 240, along with a junction 232, complete the circuit 234. Control circuit 200 is electrically connected to a power source, such as line power 250. In the embodiment shown, control circuit 200 is analog. However, control circuit 200 can be digital.

Contact setting 223 enables first limiter 230. First limiter 230 is set for non-standard cooking operation, such as canning. Setting 224 enables second limiter 240 that is set for standard cooking operations. First limiter 230 and second limiter 240 control heating element 225, which heats the cooking surface of cooktop 100. Heating element 225 is preferably a radiant heating element. First limiter 230 and second limiter 240 can be electromechanical limiters, such as, for example, thermocouplers or resistance elements.

Relay switch 220 is activated by selector switch 112 to switch between different electric circuits or different portions of an electric circuit and thus activate first limiter 230 or second limiter 240. Due to relay switch 220, first limiter 230 and second limiter 240 cannot be activated at the same time. This is important to protect against thermal overload. Relay switch 220 can be a remote-controlled switch and thus remotely control by selector switch 112. More preferably, relay switch 220 can be an electromechanical relay, a semiconductor relay, a mechanical limit selector switch, an electronic limit selector switch, or an electromechanical selector switch.

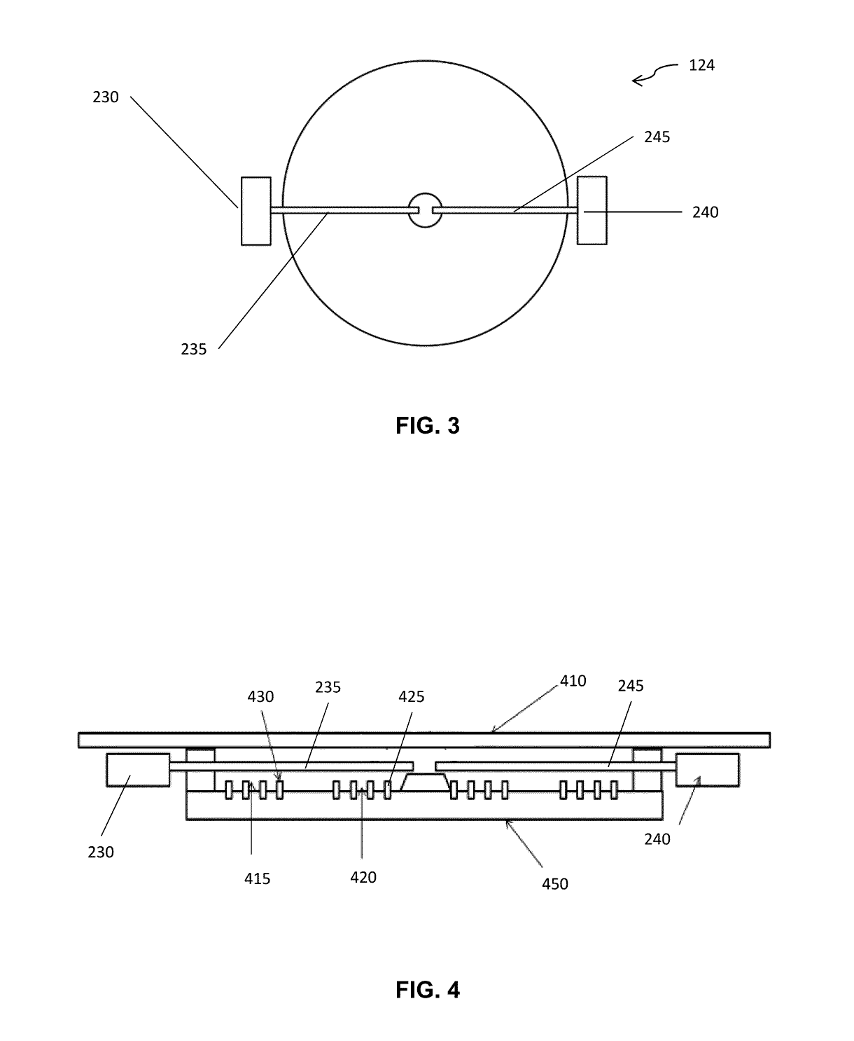

Referring to FIG. 3, first limiter 230 is operatively connected to a rod 235 beneath a glass or glass-ceramic plate 410. Likewise, second limiter 240 is operatively connected to a rod 245 beneath glass or glass-ceramic plate 410.

An inner heating circuit 420 and an outer heating circuit 415 for delivering electricity to the heating element are also shown. Heating ribbon 425 and heating ribbon 430, which comprise heating element 225, generate heat when electricity flows therethrough. Heating ribbon 425 and heating ribbon 430 are electrically connected to inner circuit 415 and outer circuit 420, respectively. An insulating material 450 is positioned under to protect any structure beneath cooktop 100 from heat damage.

Referring to FIG. 5, a cooking operation 500 of the glass or glass-ceramic cooktop system according to the present disclosure is illustrated. At step 510, switch 130 on control panel 110 switches on cooktop 100. At step 520, a cooking zone 120 is selected. Cooking zone 120 can be either a standard cooking zone, such as cooking zone 126, or a combination cooking zone, such as cooking zone 122. If a combination cooking zone 122 is selected, the appropriate setting, control 112 on control panel 110, is also selected.

If a combination cooking zone, such as cooking zone 122, is selected, then a type of cooking process must be selected at step 530, namely a standard cooking operation 540 or a non-standard cooking operation 550, such as canning.

If a standard cooking operation is selected at step 540, then a standard or single heating element 225 and first limiter 230 and standard thermal limiter setting is selected at 545. The standard thermal limiter setting is higher than the non-standard thermal limiter setting since the canning load, for example, is not taken into consideration.

If instead, a non-standard cooking operation, such as canning, is selected at step 550, then all heating circuits of heating element 225, i.e., all zones, will be actuated and a canning thermal limiter setting will be selected. The canning thermal limiter setting is lower than the standard thermal limiter setting.

Once the limiter setting is set, then there is a selection of the power level at step 560. Thereafter, at step 570, the food products are prepared and cooked on the cooktop. The process ends at step 580 with the cooktop system being switched off.

The limiter setting, which is defined by way of the temperature of the top surface of the glass or glass-ceramics, determines the cooking time, which is important for the user. The higher the temperature on the top surface of the glass or glass-ceramics, the shorter the cooking time. However, the temperature of the top surface of the glass or glass-ceramics is limited, in turn, by the temperature resistance of the glass or glass-ceramics used. In practical use, different cooking characteristics and different pot qualities lead to greatly different temperature loads on the cooking surface over different load times.

These temperature-time loads may not exceed the temperature-time load capacity limits of the respectively used glass or glass-ceramics, because, otherwise, thermal overload of the glass or glass-ceramics and hence the destruction of the cooking surface results.

In cooktop 100 of the present disclosure, electronic temperature regulation or several temperature switching points, can be implemented through the temperature sensor.

While described herein as two limiter settings, there can be three, four, or more limiter settings. Also, a limiter setting can be set to a predetermined threshold.

Heating element 225 can be designed as single-coil heating element or a multiple-zone heating element with heating diameters corresponding to its cooking zone 120. As stated above, each heating element 225 is equipped with two electromechanical limiters, or a two-step limiter with a switching contact, and/or at least one electronic temperature limiter or a thermocouple or a resistance element. The limiter allows implementation of the differing heating element settings as are required for the different cooking operations, i.e., standard and non-standard.

Heating elements 225 can be tubular heating elements, solid heating plates, and any heating systems covered with a glass or glass-ceramic. Heating elements 225 are preferably radiant heating elements, composed essentially of heating ribbon introduced onto thermal insulation. An insulation ring serves as edge insulation and, at the same time, as a spacer between the heating ribbon and the glass or glass-ceramics of cooktop 100. For example, when a voltage is applied, the heating ribbon is heated to approximately 1050° C. and emits the heat as IR radiation.

To protect the glass or glass-ceramics of cooktop 100 from overheating, an electromechanical thermal cutoff (TCO) can be installed between the heating ribbon and the glass or glass-ceramics of cooktop 100. Cutoffs are known in the art. The cutoff is composed of a rod and a head. The rod comprises two materials with different thermal expansions, which undergo different expansion in length relative to each other when they are heated. This different expansion in length serves as a trigger for a switching contact in the head. The switching temperature of the cutoff can be adjusted by way of variable spacing of the rod. Cut-offs can also have a two-step switching contact. In a two-step system, it is possible to adjust two different switching temperatures.

In addition to the electromechanical temperature cutoffs described, the cut-off can also use a thermocouple such as a type K. A type K thermocouple for example is made of nickel alloy having chrome, aluminum, manganese, and silicon. A type K thermocouple has a sensitivity of approximately 41 pV/° C., useful for temperature ranges such as −200 through −1350° C. (−330 through 2460° F.). Further, there are Type J thermocouples, Type N thermocouples, Type R thermocouples, Type S thermocouples, Type T thermocouples, Type B thermocouples, Type E thermocouples, platinum/rhodium alloy thermocouples, Iridium/rhodium alloy thermocouples, platinum/molybdenum alloy thermocouples, gold/iron alloy thermocouples, and the like.

The cut-off can also be a temperature-dependent resistor, such as a PT100 or PT1000. A PT100, for example, has the sensitivity of a standard 100 ohm sensor, a nominal 0.385 ohm/° C., but can have sensitivity between about 0.375 and 0.392 ohm/° C. Further, the use of electrically conductive print on the backside of the glass or glass-ceramic cooktop to measure changes in electrical resistance of the glass or glass ceramic material itself is contemplated. Resistance is a direct function of the glass or glass-ceramic temperature.

The electrical resistances or thermoelectric voltages of a thermocouple change in proportion to the applied temperature and, therefore, can be used for the control of different limiter settings. To regulate the temperature, an additional electronic control receives a signal from the limiter, such as first limiter 230, further processes the signal, and transmits a signal to switch via a relay 220 to heating element 225.

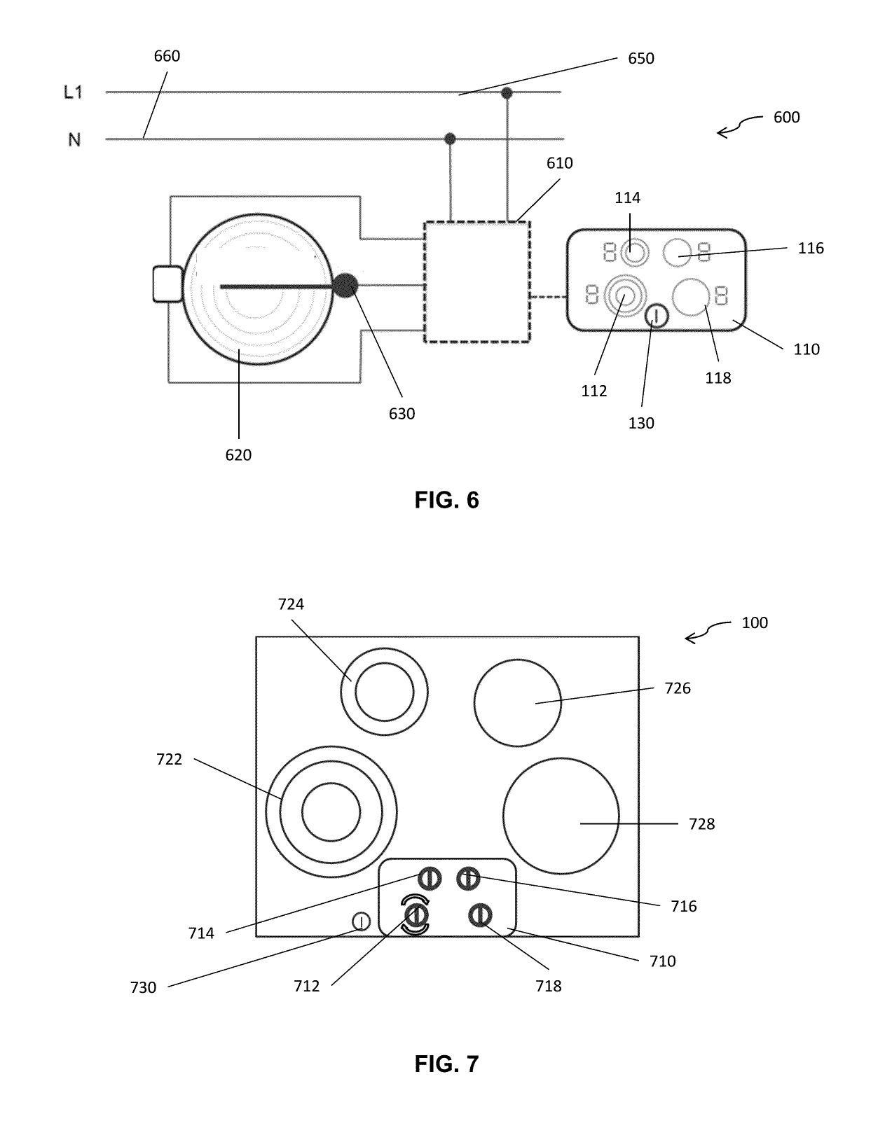

Referring to FIG. 6, there is shown a control circuit 600 that is a digital circuit, but has the same functionality as control circuit 200. Radiant heating element 620 is analogous to radiant heating element 225. Radiant heating element 620 employs a sensor 630 as a limiter. Sensor 630 controls radiant heating element 620 based on a user input from control panel 110 via control 610 which regulates line power 650 and neutral line 660.

A control circuit according to the present disclosure can also be a combination of analog and digital. For example, the control circuit can have some combination of analog components as found in control circuit 200, digital components as found in control circuit 600, and similar analog or digital components.

FIGS. 7 to 9 show other embodiments of cooktop 100 of the present disclosure.

FIG. 7 shows cooktop 100 with a control unit 710. Control unit 710 uses mechanical selector knobs 712, 714, 716 and 718 for controlling cooktop 100 and a power button 730 for energizing cooktop 100. Selector knobs 712, 714, 716, and 718 can be turned to select a type of cooking operation and a desired power level. For example, a right turn can be used to set the standard cooking operation and a left turn can be used to set the non-standard cooking operation, such as canning. Alternatively, a left turn can be used to set the standard cooking operation and a right turn can be used to set the non-standard cooking operation, such as canning. Further, some combination of a portion of knobs 712, 714, 716, and 718 can set the standard cooking operation by left turn and the non-standard cooking operation, such as canning, by right turn, while the remainder can set the standard cooking operation by right turn and non-standard cooking operation, such as canning, by left turn. In other embodiments, cooking zones 720 can be the same size, or combinations of the same and different sizes. Although illustrated as four zones, namely 722, 724, 726, and 728, there can be any number of zones and any combination of sizes.

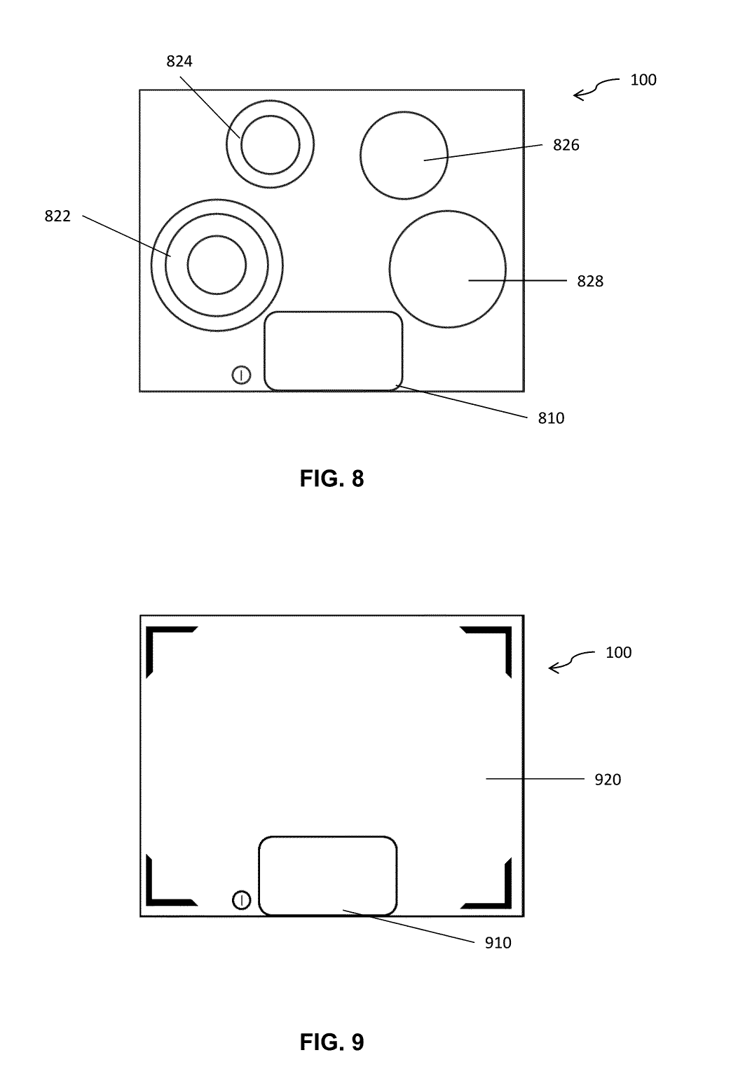

Referring to FIG. 8, cooktop 100 has a control unit that is a touch display 810. Touch display 810 presents a user with the various control settings for selecting which type of cooking operation is to be undertaken, such as a standard cooking operation or a non-standard cooking operation, for controlling the power level of the selected radiant heating elements, and for selecting which of cooking zones 822, 824, 826, and 828 are to be energized. Touch display 810 augments or implements a control mechanism for cooktop 100 that allows control by gesture, tablet coupling, computer coupling, or smartphone coupling using wired or wireless communication media. In other embodiments, cooking zones 822, 824, 826, and 828 can be the same size, or combinations of the same and different sizes. Although illustrated as four zones, there can be any number of zones and any combination of sizes.

In FIG. 9, cooktop 100 has a control unit 910 and a cooking surface 920. Cooking surface 920 has several discrete cooking zones, but they are unmarked on cooking surface 920. The cooking zones can be any shape, size, or combination thereof. Although shown with control unit 910, any of control units 110, 710, 810, or the like can be used.

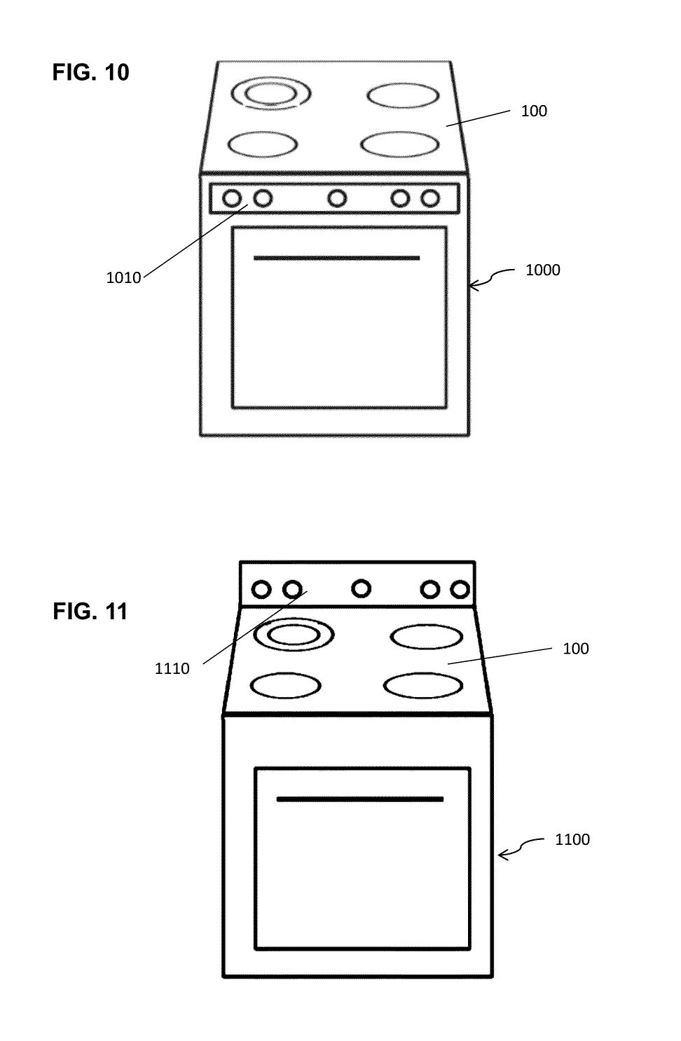

Referring to FIGS. 10 and 11, there are shown two embodiments of cooktop 100 incorporated into a standard range, oven, or stove 1000 and 1100, respectively. Stoves 1000 and 1100 have a control unit 1010 and 1110, respectively. Control units 1010 and 1110 can be any of control units 110, 710, 810 or 910, used to select the type of cooking operation, i.e., standard or non-standard, to select the desired the power levels of the heating elements, to select the cooking zones or number of cooking elements that are engaged, and/or to turn the power on and off.

In stove 1000, control unit 1010 is located in front of cooktop 100. In stove 1100, control unit 1110 is located behind cooktop 100.

The terms “first”, “second”, “third”, “upper”, “lower”, and the like can be used herein to modify various elements. These modifiers do not imply a spatial, sequential, or hierarchical order to the modified elements unless specifically stated. Also, when ranges are used herein, the ranges further include all subranges therebetween.

While the present disclosure has been described with reference to one or more exemplary embodiments, it will be understood by those skilled in the art that various changes can be made and equivalents can be substituted for elements thereof without departing from the scope of the present disclosure. In addition, many modifications can be made to adapt a particular situation or material to the teachings of the present disclosure without departing from the scope thereof. Therefore, it is intended that the present disclosure not be limited to the particular embodiment(s) disclosed as the best mode contemplated, but that the present disclosure will include all embodiments falling within the scope of the appended claims.

What is claimed:

1. A cooktop system comprising:
a glass or glass-ceramic cooktop, the cooktop having a control panel and at least one heating zone; and
a control system, wherein the control system, the control panel, and the at least one heating zone are operatively connected, and wherein the control system has a first temperature limiter setting that is suitable for a standard cooking operation and a second temperature limiter setting that is suitable for a non-standard cooking operation, the second temperature limiter setting being different from the first temperature limiter setting.

2. The cooktop system according to claim 1, wherein the control panel allows selection between the first temperature limiter setting and the second temperature limiter setting.

3. The cooktop system according to claim 1, wherein the first temperature limiter setting and the second temperature limiter setting are selectable based on a selection of the control panel.

4. The cooktop system according to claim 1, wherein the control system is selected from the group consisting of two electromechanical limiters, a two-step limiter with a switching contact, an electronic temperature limiter, a thermocouple, and a resistance element.

5. The cooktop system according to claim 1, further comprising a first heating element that has a heating diameter that corresponds to the at least one heating zone.

6. The cooktop system according to claim 5, wherein the first heating element is a single-coil heating element.

7. The cooktop system according to claim 5, further comprising a second heating element, wherein the first heating element and the second heating element can be energized independently.

8. The cooktop system according to claim 1, wherein the control system includes a relay switch for switching between the first temperature limiter setting and the second temperature limiter setting.

9. The cooktop system according to claim 1, wherein the control panel is selected from the group consisting of a touch sensor control panel, a touch display, and mechanical selector knobs.

10. The cooktop system according to claim 1, further comprising a control circuit that prevents the cooktop from overheating.

11. The cooktop system according to claim 1, wherein the at least one heating element is a first heating element and a second heating element, wherein the first heating element and the second heating element can be energized simultaneously.

12. The cooktop system according to claim 1, wherein the temperature limiter setting of the non-standard cooking operation is lower than the temperature limiter setting of the standard cooking operation.

13. The cooktop system according to claim 1, wherein the non-standard cooking operation is a canning operation.

14. The cooktop system according to claim 1, wherein the control panel is mounted on a stove either behind a cooking surface or in front of the cooking surface.

15. A method for performing standard and non-standard cooking operations on glass or glass-ceramic cooktop having a cooking zone comprising:
activating the cooking zone, wherein the cooking zone is heated by a heating element;
selecting a cooking process from between a non-standard cooking operation and a standard cooking operation;
adjusting a limiter setting based on the selecting the cooking process; and
selecting a power level for the cooking zone.

16. The method of claim 15, wherein the cooking zone is a plurality of cooking zones, and the method further comprising activating a remainder of the plurality cooking zones.

17. The method of claim 15, wherein the non-standard cooking operation is a canning operation.

18. The method of claim 15, further comprising limiting power to the cooking zone when a temperature of the cooking zone exceeds a predetermined threshold.

19. The method of claim 15, further comprising a predetermined threshold for the non-standard and the standard cooking operations.

20. The method of claim 19, wherein the predetermined threshold for the non-standard cooking operation is different from the predetermined threshold of the standard cooking operation.
